(19) United States
(12) Patent Application Publication
(10) Pub. No.: US 2005/0276677 A1
(43) Pub. Date: Dec. 15, 2005

(54) Load carrier support

(76) Inventors: Göran Andersson, Boras (SE); Fredrik Kristoffersson, Boras (SE)

Correspondence Address: HARNESS, DICKEY & PIERCE, P.L.C., P.O. BOX 8910, RESTON, VA, 20195, US

(21) Appl. No.: 10/506,062

(22) PCT Filed: Mar. 17, 2003
(86) PCT No.: PCT/SE03/00437

§ 371 Date: Aug. 31, 2004

(30) Foreign Application Priority Data
Mar. 25, 2002 (SE) 0200892-8

(51) Int. Cl. F16B 21/00

(52) U.S. Cl. 411/551; 411/553

(57) ABSTRACT

A carrier support adapted to be attached to an element, preferably a vehicle roof (4), the element being provided with a recess (5) intended for the attachment. The carrier support comprises an anchor element (1) having a head (2) and a shank (3), which head (2) has a first radial extent from the axis of the shank (3) at a first angle which is smaller than the extent of said recess (5) at one angle, and a second radial extent at a second angle which is greater than the extent at said angle of said recess (5). The carrier support further comprises a locking element (6) comprising at least one projection (7) and a hole, the size of the hole being adapted so that the shank (3) of the anchor element (1) is insertable in said hole, the projection (7) being located adjacent to the hole at a distance from the centre of the hole that is at least as great as the smaller extent of the anchor head (1). The carrier support also comprises a second locking element (9) which, in the assembled state, is adapted to lock said locking element (6) with the projection (7) positioned next to the anchor element (1), so that the projection (7) is arranged at the side of the anchor head (2) located the shortest distance from the axis of the shank (3).

### FIELD OF THE INVENTION

The present invention relates to a carrier support adapted to be attached to an element, preferably a vehicle roof, said element being provided with a recess intended for the attachment.

### BACKGROUND ART

Carrier supports of the kind mentioned by way of introduction are generally known in the art. However, there are many variants and it is not always obvious to the layman how the attachment should be done in order to ensure correct and, thus, safe positioning of said supports. Moreover, in the case of vehicle roof mounting it is important to ensure sufficient sealing of the attachment hole in the roof to prevent moisture from penetrating into the vehicle.

### SUMMARY OF THE INVENTION

The object of the present invention is therefore to provide a carrier support which solves the above-mentioned problems.

According to the invention, the object is achieved by the carrier support of the kind stated by way of introduction having the features stated in appended claim 1. Preferred embodiments of the carrier support will be apparent from the dependent claims.

Thus, the carrier support according to the invention comprises an anchor element having a head and a shank. The head has a first radial extent from the axis of the shank at a first angle which is smaller than the extent of said recess at one angle, and a second radial extent at a second angle which is greater than the extent at said angle of said recess. The carrier support further comprises a locking element comprising at least one projection and a hole, the size of the hole being adapted so that the shank of the anchor element is insertable in said hole. The projection is located adjacent to the hole at a distance from the centre of the hole that is at least as great as the smaller extent of the anchor head. The carrier support also comprises a second locking element which, in the assembled state, is adapted to lock said locking element with the projection positioned next to the anchor element, so that the projection is arranged at the side of the anchor head located the shortest distance from the shank axis. Owing to this special construction, it is difficult to mount the carrier in an incorrect manner.

According to a preferred embodiment of the invention, said first locking element comprises two projections arranged on either side of the hole in the base element. This arrangement gives the advantage of considerably improved carrier support stability and, at the same time, increased strength.

According to a preferred embodiment of the invention, the shank of the anchor element is threaded and said second locking element is a nut. The advantage of threaded shanks and nuts is that standard nuts and tools can be used to carry out the attachment.

Furthermore, said first locking element is suitably elastic. As said second locking element locks said first locking element, the elasticity will allow said first locking element to seal the recess.

Moreover, it is appropriate for a washer to be arranged between said two locking elements to eliminate any wear on said first locking element and to obtain a better sealing effect, in particular in the case where said first locking element is elastic.

Preferably, a recess is provided in the washer, the size of said recess being adapted to said first locking element. This ensures correct positioning of the washer relative to said first locking element and further improves the sealing effect.

To facilitate mounting and dismounting, two flat surfaces are preferably provided on either side of the anchor element shank to allow engagement of tools, said surfaces being preferably located on the end portion of the shank that is furthest away from the anchor element head. This applies in particular when the shank is threaded and it is difficult to get a hold without damaging the threads.

### BRIEF DESCRIPTION OF THE DRAWINGS

The invention will be described in greater detail below with reference to the accompanying schematic drawings, which for exemplifying purposes illustrate a currently preferred embodiment of the invention and in which

FIGS. 1a-1e illustrate, in perspective, the principle of mounting the carrier support; and

FIG. 2 is a cross-sectional view of the carrier support in FIG. 1 in the assembled state.

### DESCRIPTION OF A PREFERRED EMBODIMENT

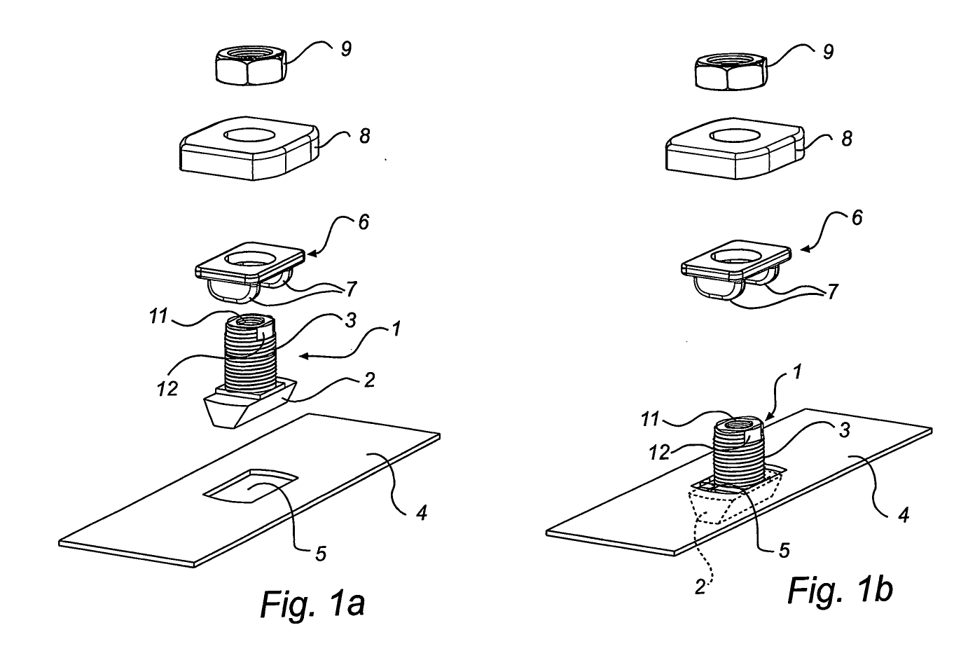

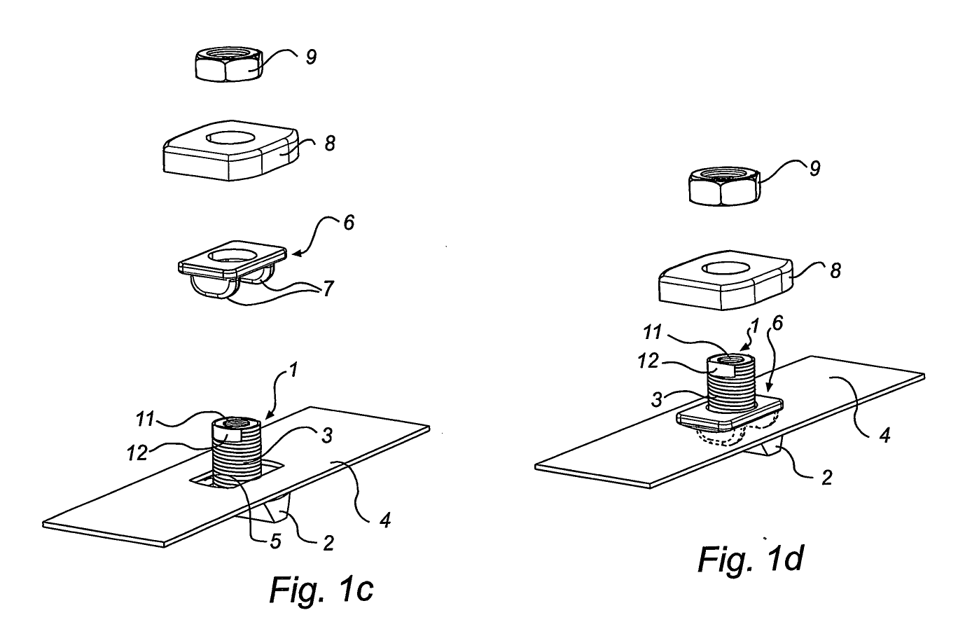

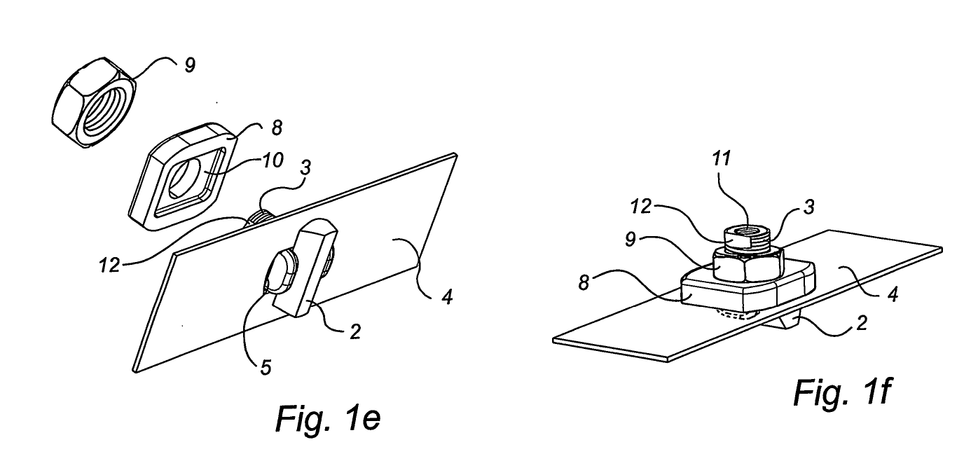

The carrier support in FIG. 1 comprises an anchor element 1, which has a head 2 and a shank 3. In a preferred embodiment of the present invention, the shank 3 is threaded and, in the end portion furthest away from the head 2, provided with two flat opposite portions 12 to facilitate the engagement of, for instance, an adjustable spanner. In a currently preferred embodiment of the invention, the shank 3 comprises a threaded hole 11. The threaded hole 11 is intended to receive, for example, a part of, for instance, a roof rack, said part being complementary to the hole 11. During mounting, the anchor element 1 is inserted in an opening 5 (see FIGS. 1a and 1b) provided in the vehicle roof 4. FIG. 1c shows how the anchor element 1 has been rotated through 90 degrees to obtain an upward lock thereof.

A first locking element 6 with projections 7 is then arranged over the opening 5 (see FIG. 1d) so that the projections 7 extend into the opening 5. When correctly mounted the projections 7 will be located along the longitudinal edges of the anchor head. In a preferred embodiment of the present invention, the length of the projections 7 corresponds to the width of the opening 5 so as to lock the anchor element 1 at the correct angle relative to the opening (5). Once the locking element 6 is positioned, a washer 8 is arranged over the locking element 6, the washer 8 in a preferred embodiment having a recess 10 which corresponds to the contours of the locking element 6 (see FIG. 1e).

Finally, a nut 9 (said second locking element) is arranged to form, together with said second element, a carrier support according to the present invention (see FIG. 1f).

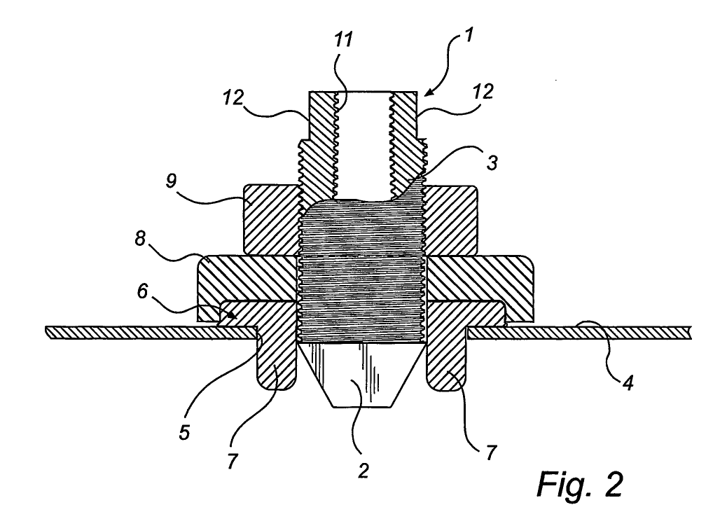

FIG. 2 shows in greater detail how said first locking element 6 due to its elasticity is compressed between the washer 8 and the roof 4, which thus increases the tightness. To obtain the same tightness, an inelastic locking element 6 needs to have greater evenness.

It will be appreciated that various modifications of the embodiment of the invention described above are conceivable within the scope of the invention, as defined by the appended claims. Accordingly, the final locking by means of the nut 9 and the threaded shank 3 of the anchor element 1 as described above may, for example, be replaced by some type of snap-on device. Moreover, it is conceivable to use the carrier support in applications other than vehicle roofs, such as wall mounts. It is also conceivable for the anchor head 2 to have another shape, for example a cross-shape or a star-shape, and for the opening 5 and the locking element 6 to have a shape that is complementary to the anchor head 2.

1. A carrier support adapted to be attached to an element, preferably a vehicle roof (4), the element being provided with a recess (5) intended for the attachment and comprising an anchor element (1) having a head (2) and a shank (3), which head (2) has a first radial extent from the axis of the shank (3) at a first angle which is smaller than the extent of said recess (5) at one angle, and a second radial extent at a second angle which is greater than the extent at said angle of said recess (5), an elastic locking element (6) comprising at least one projection (7) and a hole, the size of the hole being adapted so that the shank (3) of the anchor element (1) is insertable in said hole, the projection (7) being located adjacent to the hole at a distance from the centre of the hole that is at least as great as the smaller extent of the anchor head (1), and a second locking element (9) which, in assembled state, is adapted to lock said first locking element (6) with the projection (7) positioned next to the anchor element (1), so that the projection (7) is arranged at the side of the anchor head (2) located the shortest distance from the axis of the shank (3), characterised in that a washer (8) is arranged between said first and second locking elements (6, 9), wherein the washer (8) has a recess (10) on the side which, in the assembled state, is oriented toward said first locking element (6), the shape of said recess (10) corresponding to the shape of said first locking element (6).

2. A carrier support as claimed in claim 1, wherein said first locking element (6) comprises two projections (7) arranged on either side of the recess (5) in the base element.

3. A carrier support as claimed in claim 1, wherein the shank (3) of the anchor element (1) is threaded and wherein said second locking element is a nut (9).

4. A carrier support as claimed in claim 1, wherein two flat surfaces (12) are provided on either side of the shank (3) to allow engagement of a tool.
